(19) United States
(12) Patent Application Publication
(10) Pub. No.: US 2017/0262512 A1
(43) Pub. Date: Sep. 14, 2017

(54) SEARCH PROCESSING METHOD, SEARCH PROCESSING APPARATUS, AND NON-TRANSITORY COMPUTER-READABLE RECORDING MEDIUM STORING SEARCH PROCESSING PROGRAM

(71) Applicant: FUJITSU LIMITED, Kawasaki-shi (JP)

(72) Inventors: Yasunobu Moriyama, Yokohama (JP); Masahiko Nagata, Kawasaki (JP)

(73) Assignee: FUJITSU LIMITED, Kawasaki-shi (JP)

(21) Appl. No.: 15/381,949

(22) Filed: Dec. 16, 2016

(30) Foreign Application Priority Data
Mar. 8, 2016 (JP) 2016-044186

(51) Int. Cl. G06F 17/30

(52) U.S. Cl. CPC G06F 17/30554; G06F 17/30327

(57) ABSTRACT

A search processing method includes: receiving, by a computer, a search condition; determining, based on first information which associates a first attribute value of a first attribute, which is unique, with an attribute value group including a second attribute value of one or more second attributes other than the first attribute, whether the attribute value group associated with the first attribute value satisfies the search condition for each of the first attribute value; and outputting the first attribute value associated with the attribute value group determined to satisfy the search condition.

### CROSS-REFERENCE TO RELATED APPLICATION

This application is based upon and claims the benefit of priority of the prior Japanese Patent Application No. 2016-044186, filed on Mar. 8, 2016, the entire contents of which are incorporated herein by reference.

### FIELD

The embodiments discussed herein are related to a search processing method, a search processing apparatus, and a non-transitory computer-readable recording medium storing a search processing program.

### BACKGROUND

A materialized view is used for data reference.

Related technologies are disclosed in, for example, Japanese Laid-Open Patent Publication No. 2013-117873.

### SUMMARY

According to one aspect of the embodiments, a search processing method includes: receiving, by a computer, a search condition; determining, based on first information which associates a first attribute value of a first attribute, which is unique, with an attribute value group including a second attribute value of one or more second attributes other than the first attribute, whether the attribute value group associated with the first attribute value satisfies the search condition for each of the first attribute value; and outputting the first attribute value associated with the attribute value group determined to satisfy the search condition.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of a system;

FIG. 2 illustrates an example of data to be retrieved;

FIG. 3 illustrates an example of a management method of data to be retrieved;

FIGS. 4A to 4D each illustrate an example of data stored in a management data storing unit;

FIG. 5 illustrates an example of a tree structure represented by management data;

FIG. 6 illustrates an example of data stored in a data storing unit;

FIG. 7 is a flow chart illustrating an example of processing in a case where an add request has been received;

FIGS. 8A to 8C each illustrate an example of command data included in the add request, an update request, and a delete request, respectively;

FIG. 9 is a flow chart illustrating an example of processing in a case where a search request has been received;

FIGS. 10A to 10C each illustrate an example of the search request;

FIG. 11 illustrates an example of data for managing a determination result;

FIG. 12 illustrates an example of an association operation during a search process;

FIG. 13 illustrates an example of the association operation during the search process;

FIG. 14 illustrates an example of a search method;

FIGS. 15A to 15C each illustrate an example of a search using a materialized view;

FIGS. 16A and 16B each illustrate an example of the search using the materialized view;

FIG. 17 illustrates an example of the search using the materialized view;

FIG. 18 illustrates an example of a tree structure;

FIG. 19 illustrates an example of the search; and

FIG. 20 illustrates an example of a functional block of a computer.

### DESCRIPTION OF EMBODIMENTS

Since a materialized view is a permanent view having a substance unlike a normal view in a database management system (DBMS), the materialized view does not disappear even though reference is terminated. Therefore, when a specific view is frequently referenced, processing is accelerated by omitting an operation executed every reference, by using the materialized view.

For example, since an original table and the materialized view are not necessarily synchronized in real time, data which is not up to date may be referenced. For example, when the data is updated, since both the update of the original table and regeneration of the materialized view are performed, processing may be delayed.

For example, when the materialized view is generated from a plurality of tables storing a plurality of attribute values for a certain target, the number of records of the materialized view may become large and in actuality, the materialized view may not be generated. Further, although the materialized view is generated, when the number of records is large, the processing may not be performed in real time.

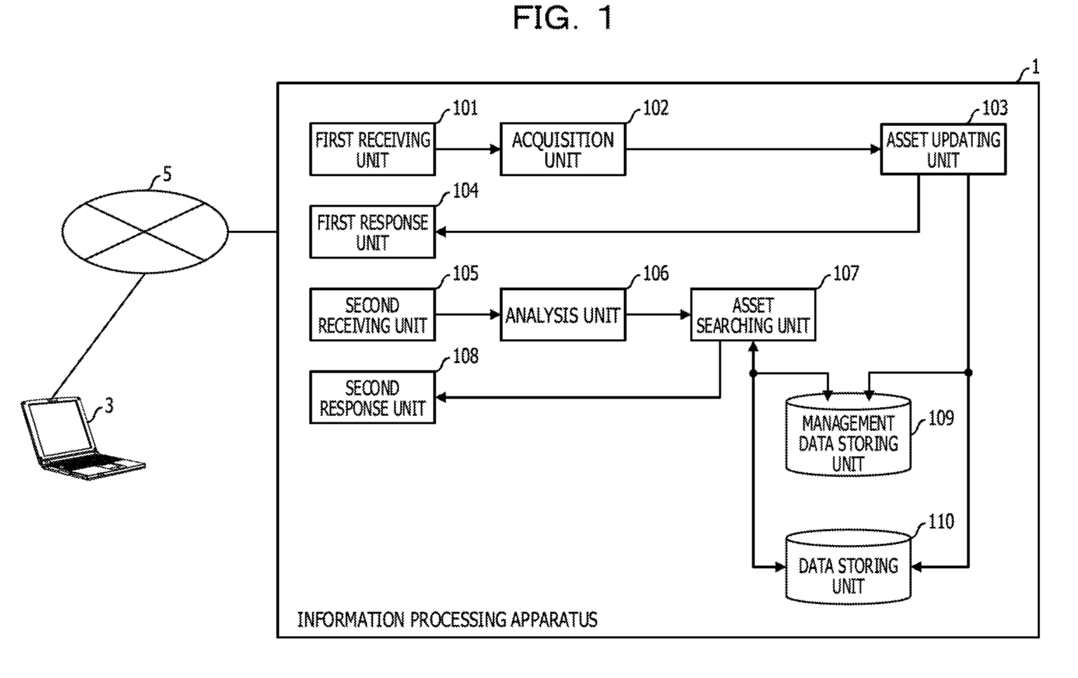

FIG. 1 illustrates an example of a system. An information processing apparatus 1 executing primary processing is coupled to, for example, a network 5 which is a local area network (LAN). A user terminal 3 operated by a user is coupled to the network 5.

The information processing apparatus 1 includes a first receiving unit 101, an acquisition unit 102, an asset updating unit 103, a first response unit 104, a second receiving unit 105, an analysis unit 106, an asset searching unit 107, a second response unit 108, a management data storing unit 109, and a data storing unit 110.

The first receiving unit 101 receives an add request for adding the record, an update request for updating the record, and a delete request for deleting the record from the user terminal 3, and outputs the add request, the update request, and the delete request to the acquisition unit 102. The acquisition unit 102 acquires command data including key information from the requests received from the user terminal 3 and outputs the acquired command data to the asset updating unit 103. The asset updating unit 103 updates at least any one of data stored in the management data storing unit 109 and data stored in the data storing unit 110 according to the command data received from the acquisition unit 102. The asset updating unit 103 notifies the first response unit 104 that the update is completed. The first response unit 104 transmits data to the user terminal 3 indicating that the update is completed.

The second receiving unit 105 receives the search request for searching the record from the user terminal 3 and outputs the received search request to the analysis unit 106. The analysis unit 106 analyzes the search request received from the user terminal 3 and outputs a search condition, a logic operator and the like included in the search request to the asset searching unit 107. The asset searching unit 107 acquires a record set from the data storing unit 110 based on the data received from the analysis unit 106 and the data stored in the management data storing unit 109. The asset searching unit 107 outputs the acquired record set to the second response unit 108. The second response unit 108 transmits data including the received record set to the user terminal 3.

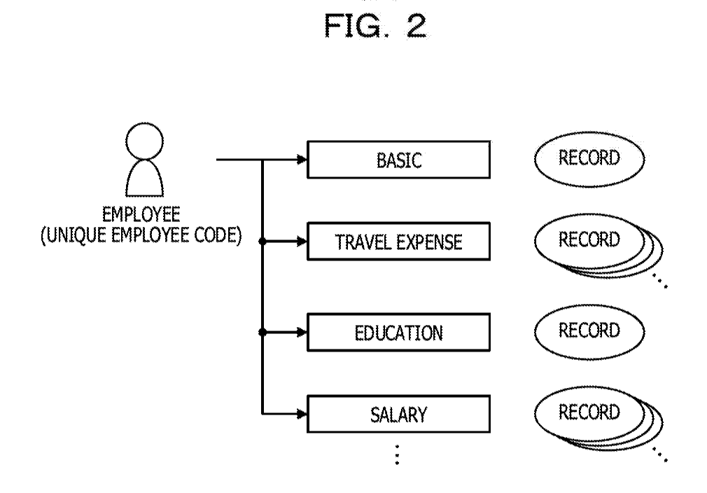

FIG. 2 illustrates an example of data to be retrieved. For example, data for targets represented by the plurality of attribute values may be data to be retrieved. The data to be retrieved may be, for example, employee information illustrated in FIG. 2. The employee information includes basic information (hereinafter, referred to as basic data) including information on a work place and the like, information on a travel expense (hereinafter, referred to as travel expense data), information on education (hereinafter, referred to as education data), and information on a salary (hereinafter, referred to as salary data) which are associated with, for example, a unique and unduplicated employee code. In the information, an updated timing varies depending on a type of information and further, the number of records also varies. For example, in the salary data, the record is added once a month, but in the education data (for example, a score of English, and the like), the record is irregularly updated or added. For example, the number of records of the travel expense data and the number of records of the salary data increase as an employment period is lengthened, but the number of records associated with a birth date is one (1) and does not vary.

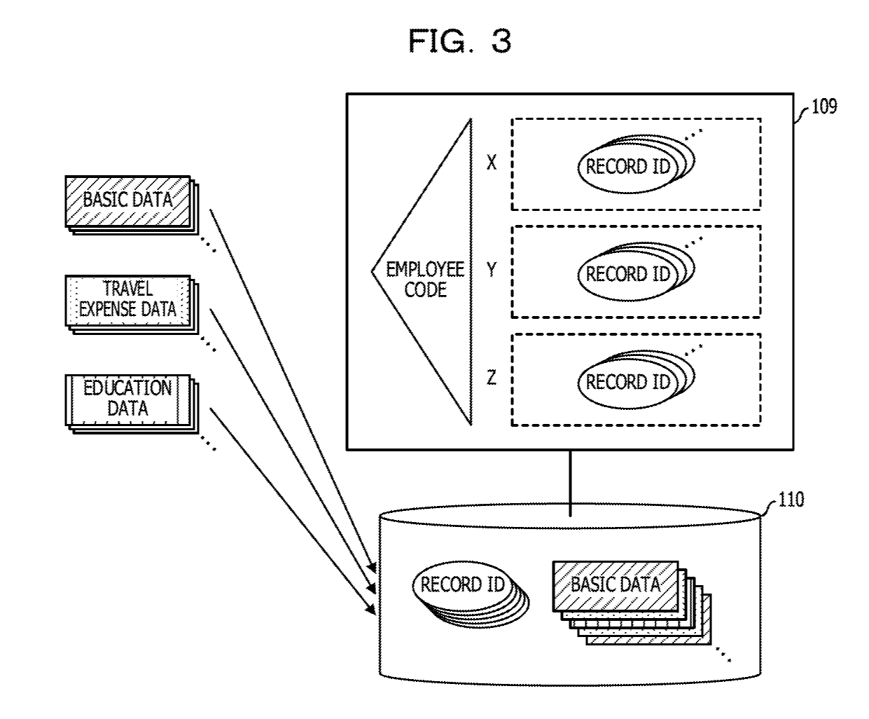

FIG. 3 illustrates an example of a management method of data to be retrieved. In FIG. 3, a rectangle in which a hatch is inserted represents the record and an ellipsoidal figure represents a record identifier (ID) of the record. The record of the basic data, the record of the travel expense data, and the record of the education data are stored in the data storing unit 110 in a receiving order and the record ID is allocated to each record. In the management data storing unit 109, the record ID of the record of the basic data, the record ID of the record of the travel expense data, and the record ID of the record of the education data are bound by the employee code.

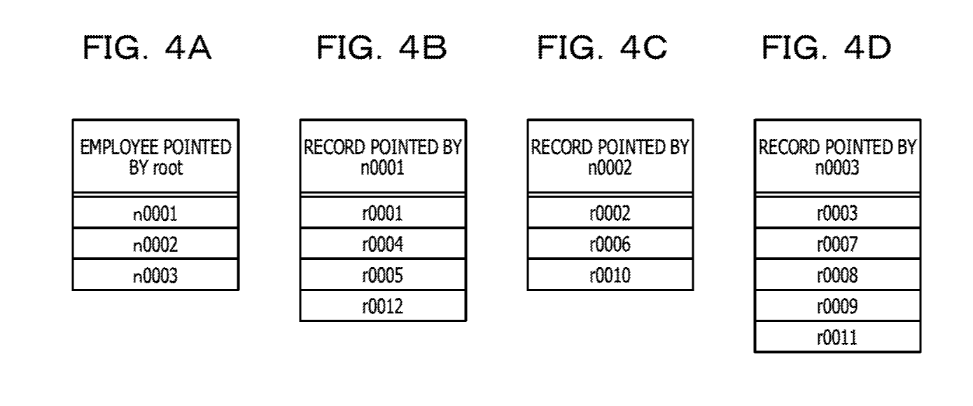

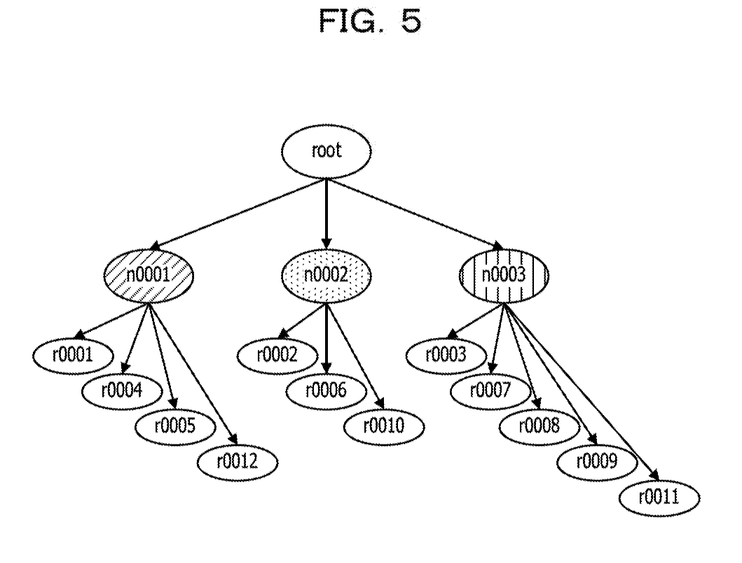

FIGS. 4A to 4D each illustrate an example of manage data stored in a management data storing unit. FIG. 5 illustrates an example of a tree structure represented by the management data. The data illustrated in FIGS. 4A to 4D may be stored in the management data storing unit 109 illustrated in FIG. 1. FIG. 4A illustrates an employee code of an employee pointed by a root of a tree represented by the management data. FIGS. 4B, 4C, and 4D each illustrate a record ID of a record pointed by each employee code. The structure of the tree represented by the management data may be the structure illustrated in FIG. 5. As illustrated in FIG. 5, the employee code is coupled to the root and the record ID of the employee record to which the employee code is granted is coupled to the employee code. Hereinafter, a tree formed by one employee code and one or a plurality of records IDs will be referred to as a node. In FIG. 5, three nodes are present.

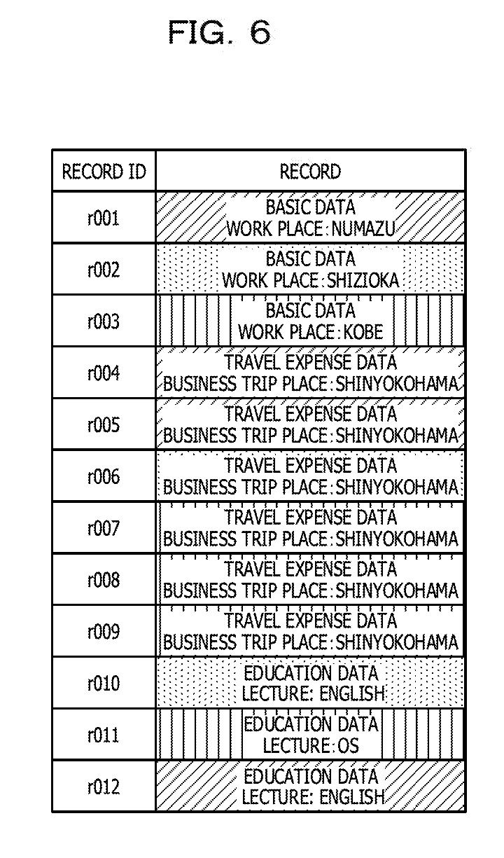

FIG. 6 illustrates an example of data stored in a data storing unit. In FIG. 6, the record ID and the record are stored. The record is stored in a receiving order.

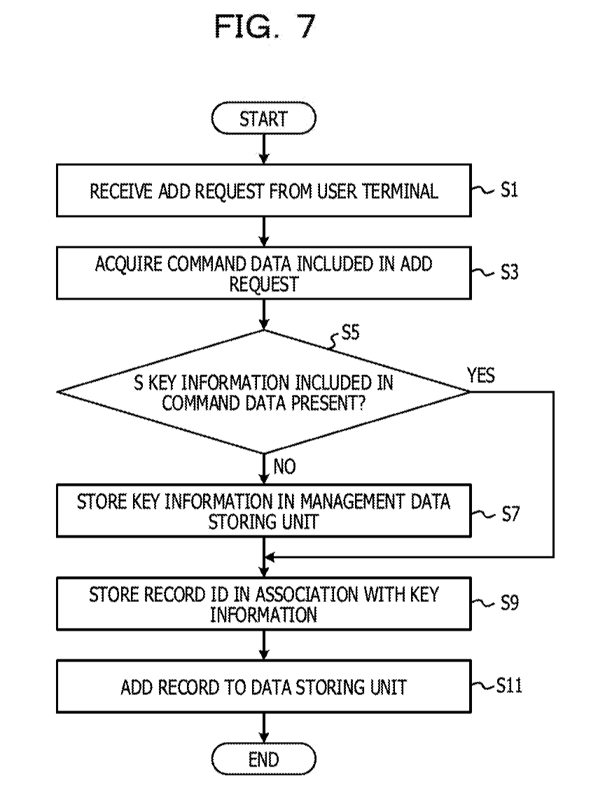

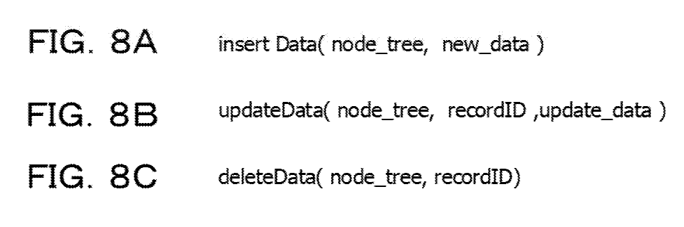

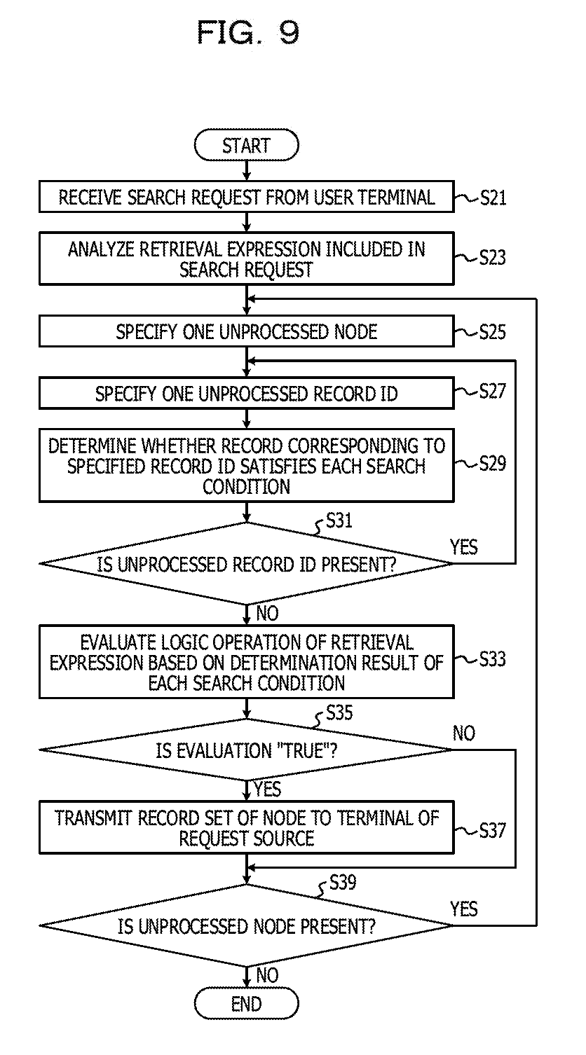

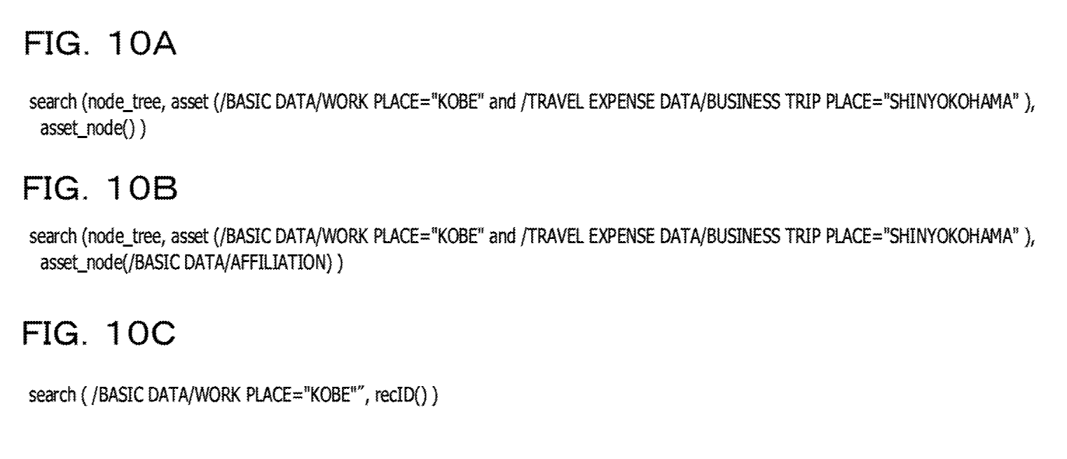

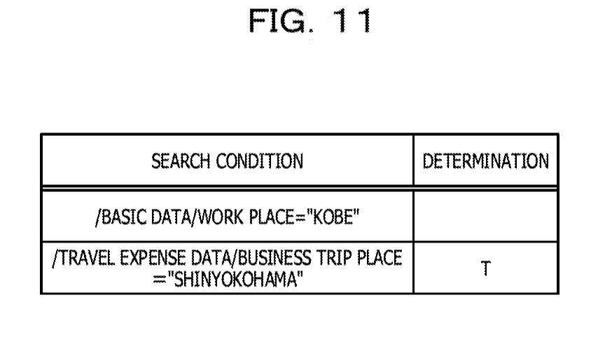

An operation of the information processing apparatus 1 is described by using FIGS. 7 to 11. FIG. 7 is a flow chart illustrating an example of processing in a case where an add request has been received. FIGS. 8A to 8C each illustrate an example of command data included in the add request, an update request, and a delete request, respectively. FIG. 9 is a flow chart illustrating an example of processing in a case where a search request has been received. FIGS. 10A to 10C each illustrate an example of the search request. FIG. 11 illustrates an example of data for managing a determination result. In FIGS. 7 and 8A to 8C, processing executed when the information processing apparatus 1 receives the add request is illustrated.

The first receiving unit 101 of the information processing apparatus 1 receives the add request from the user terminal 3 (Operation S1 of FIG. 7) and outputs the add request to the acquisition unit 102. The acquisition unit 102 acquires the command data from the add request (Operation S3) and outputs the acquired command data to the asset updating unit 103. FIG. 8A illustrates an example of the command data included in the add request. The “new_data” is added to the data storing unit 110 by the command data.

FIG. 8B illustrates an example of the command data included in the update request. A record to which “recordID” is granted is updated to “update_data” by the command data. FIG. 8C illustrates an example of the command data included in the delete request. The record to which “recordID” is granted is deleted by the command data.

The asset updating unit 103 determines whether key information included in the acquired command data such as, for example, the employee code or “node_tree” illustrated in FIGS. 8A to 8C is stored in the management data storing unit 109 (Operation S5).

When it is determined that the key information included in the command data is stored in the management data storing unit 109 (Operation S5, Yes route), the processing proceeds to Operation S9. When it is determined that the key information included in the command data is not stored in the management data storing unit 109 (Operation S5, No route), the asset updating unit 103 stores the key information included in the command data in the management data storing unit 109 (Operation S7).

The asset updating unit 103 stores a newly allocated record ID, for example, a subsequent record ID of a last allocated record ID in the management data storing unit 109 as an ID of a record pointed by the key information stored in Operation S7 (Operation S9).

The asset updating unit 103 associates the record included in the command data, for example, the “new_data” illustrated in FIGS. 8A to 8C with the newly allocated record ID to store the “new_data” associated with the newly allocated record ID in the data storing unit 110 (Operation S11). The processing ends.

The asset updating unit 103 notifies the first response unit 104 that the update is completed. The first response unit 104 transmits data indicating that the update is completed to the user terminal 3 which is a terminal of a request source.

By executing such processing, data having a smaller size than the secondary information such as the materialized view is generated. The data to be retrieved in actuality is updated in real time by using the management data storing unit 109 and the data storing unit 110 described above. As a result, a processing delay caused by update processing may not occur.

In FIGS. 9 to 11, processing executed when the information processing apparatus 1 receives the search request is illustrated. FIG. 9 is a flow chart illustrating an example of processing in a case where the search request has been received. FIGS. 10A to 10C each illustrate an example of the search request. FIG. 11 illustrates an example of data for managing a determination result.

The second receiving unit 105 of the information processing apparatus 1 receives the search request from the user terminal 3 (Operation S21 of FIG. 9) and outputs the received search request to the analysis unit 106. The analysis unit 106 analyzes a retrieval expression included in the search request received from the second receiving unit 105 (Operation S23) and acquires the search condition, the logic operator and the like from the retrieval expression. The analysis unit 106 outputs the acquired search condition, logic operator and the like to the asset searching unit 107.

In respect to the search request illustrated in FIG. 10A, a node associated with the record ID of the record having “Kobe” as the work place and the record ID of the record having “Shinyokohama” as a business trip place is retrieved and a node set of the corresponding node (the key information and each record) is replied. In respect to the search request illustrated in FIG. 10B, the node associated with the record ID of the record having “Kobe” as the work place and the record ID of the record having “Shinyokohama” as the business trip place is retrieved and the record corresponding to “/basic data/affiliation” of the corresponding node and the record ID thereof are replied.

FIG. 10C illustrates an example of the search request in a case where the above-described method is not used. The search is performed per record by the search request and the record ID of the corresponding record is replied. In this case, the search is not performed per node as described above.

The asset searching unit 107 specifies one of unprocessed nodes among the nodes registered in the management data storing unit 109 (Operation S25).

The asset searching unit 107 specifies one of unprocessed record IDs among the record IDs associated with the employee code of the node specified in Operation S25 from the management data storing unit 109 (Operation S27).

The asset searching unit 107 specifies the record associated with the record ID specified in Operation S27 from the data storing unit 110 and determines whether the specified record satisfies each search condition (Operation S29). For example, when the specified record is the record of record ID “r0004” illustrated in FIG. 6 and further, the search condition included in the retrieval expression is “/basic data/work place=“Kobe”” and “/travel expense data/business trip place=“Shinyokohama,”” it is determined that the search condition “/travel expense data/business trip place=“Shinyokohama”” is satisfied. A result of the determination may be managed by the data illustrated in FIG. 11, which is stored in a memory. In FIG. 11, “T” is stored with respect to the search condition which is determined to be satisfied. Nothing is stored with respect to the search condition determined not to be satisfied. The data is generated at the time when processing for one node starts and deleted at the time when the processing for the node ends.

The asset searching unit 107 determines whether the unprocessed record ID is present among the record IDs associated with the employee code of the node specified in Operation S25 (Operation S31). When it is determined that the unprocessed record ID is present (Operation S31, Yes route), the processing returns to Operation S27.

When it is determined that the unprocessed record ID is not present (Operation S31, No route), the asset searching unit 107 evaluates a logic operation of the retrieval expression based on the determination result of each search condition (Operation S33). For example, the determination result illustrated in FIG. 11 may be obtained with respect to a certain node and further, when the retrieval expression is the retrieval expression (/basic data/work place=“Kobe” and/travel expense data/business trip place=“Shinyokohama”) illustrated in FIG. 10A, a second search condition is satisfied, but a first search condition is not satisfied, and therefore, the evaluation of the logic operation becomes “false”.

The asset searching unit 107 determines whether the evaluation in Operation S33 is “true” (Operation S35). When it is determined that the evaluation in Operation S33 is not “true” (Operation S35, No route), the processing proceeds to Operation S39.

When it is determined that the evaluation in Operation S33 is “true” (Operation S35, Yes route), the asset searching unit 107 outputs, to the second response unit 108, the record set of the node specified in Operation S25, for example, all records and employee codes for the node. The second response unit 108 transmits the record set received from the asset searching unit 107 to the user terminal 3 which is the terminal of the request source (Operation S37). In Operation S37, the record set is transmitted, but only a part of the record set may be transmitted according to the contents of the retrieval expression.

The asset searching unit 107 determines whether the unprocessed node is present (Operation S39). When it is determined that the unprocessed node is present (Operation S39, Yes route), the processing returns to Operation S25. When it is determined that the unprocessed node is not present (Operation S39, No route), the processing ends.

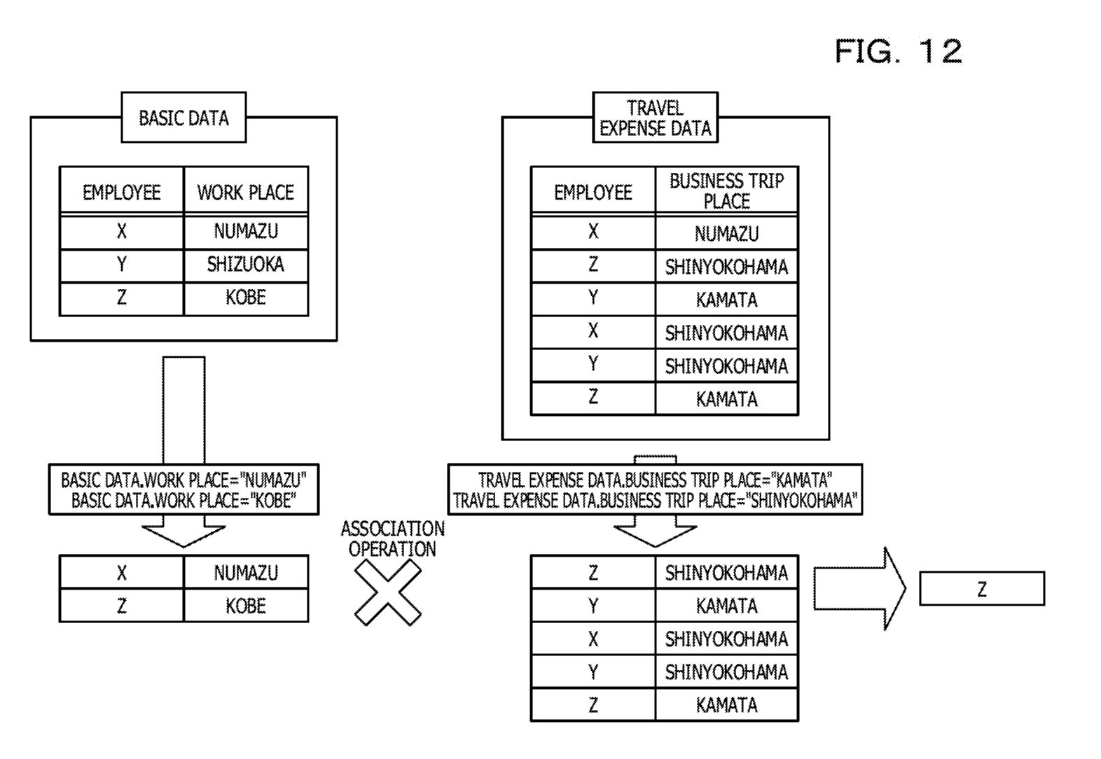

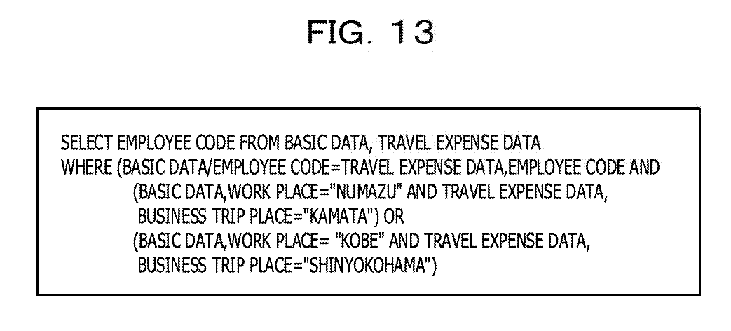

In FIGS. 12 and 13, an association operation is executed during the search. FIGS. 12 and 13 illustrate one example of the association operation during the search. In FIG. 12, the relationship between the employee and the work place is 1:1, but the relationship between the employee and the business trip place is 1:k (k is a natural number). A record satisfying “basic data. Work place=“Numazu”” and a record satisfying “basic data. Work place=“Kobe”” are extracted from a table of the basic data. A record satisfying “travel expense data. Business trip place=“Kamata”” and a record satisfying “travel expense data. Business trip place=“Shinyokohama”” are extracted from a table of the travel expense data. For example, the record satisfying the search condition is extracted from each table according to a structured query language (SQL) illustrated in FIG. 13. A relationship operation between the records, for example, the association operation is executed to derive a result. For example, employee “Z” may be a final result.

In the method illustrated in FIGS. 12 and 13, the number of records of an intermediate result extracted from each table may be large. As a result, the number of records which become a target of the relationship operation may be large. It may be premised that an execution plan during the operation is prepared in advance.

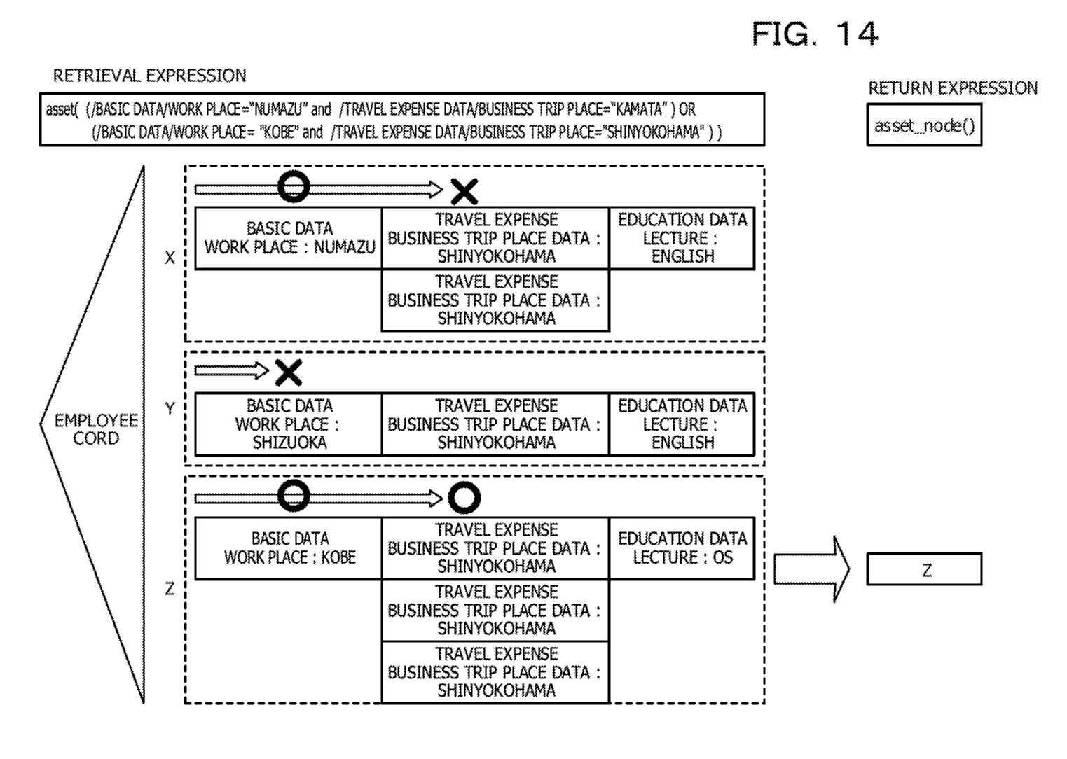

For example, as illustrated in FIG. 14, the determination is performed for each node. In FIG. 14, the determination is performed in respect to the node of employee “X” and thereafter, the determination is performed in respect to the node of employee “Y” and last, the determination is performed in respect to the node of employee “Z”. The final result may be employee “Z”.

By the above description, the association operation is virtually performed with respect to heterogeneous records without causing a large amount of intermediate results during the association operation to perform the determination while regarding the heterogeneous records as one datum. As a result, a high-speed search may be executed.

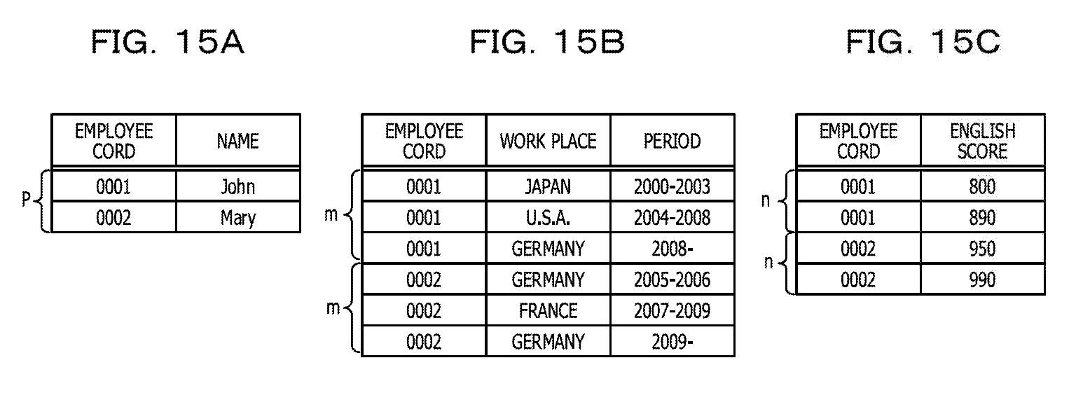

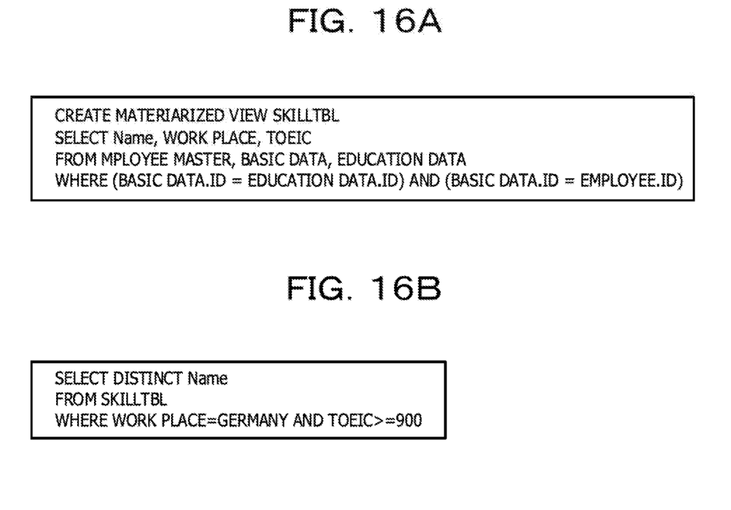

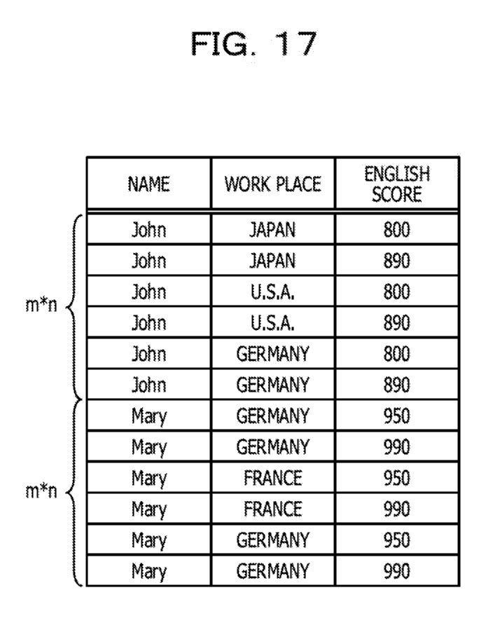

In FIGS. 15A to 15C to FIG. 17, the search is executed using the materialized view. FIGS. 15A to 15C each illustrate an example of the search using the materialized view. FIGS. 16A and 16B each illustrate an example of the search using the materialized view. FIG. 17 illustrates an example of the search using the materialized view. For example, FIGS. 15A to 15C each illustrate a plurality of tables in which information on employees working in an enterprise is accumulated. In FIG. 15A, an employee master whose name is stored in association with the employee code is illustrated. In FIG. 15B, a basic data table in which the work place and the employment period are stored in association with the employee code is illustrated. In FIG. 15C, an education data table in which the score of English is stored in association with the employee code is illustrated.

The symbol “P” represents the number of employees, “m” represents an average of the number of attribute values of the basic data per person, and “n” represents an average of the number of attribute values of education data attributes per person.

The three tables illustrated in FIGS. 15A to 15C are processed by, for example, the code illustrated in FIG. 16A to generate the materialized view. In FIG. 17, an example of the generated materialized view is illustrated. In FIG. 17, the name, the work place, and the score of English are included in the materialized view. For example, an inquiry about the materialized view is made by the code illustrated in FIG. 16B. According to the code of FIG. 16B, an employee having the English score of 900 or more while holding a working experience in Germany is retrieved.

In this case, the number of records of the materialized view is represented by P*m*n. When the data size of the name is Sα, the data size of the work place is Sβ, and the data size of the English score is Sγ, the data size of the materialized view is represented by (P*m*n)*(Sα+Sβ+Sγ).

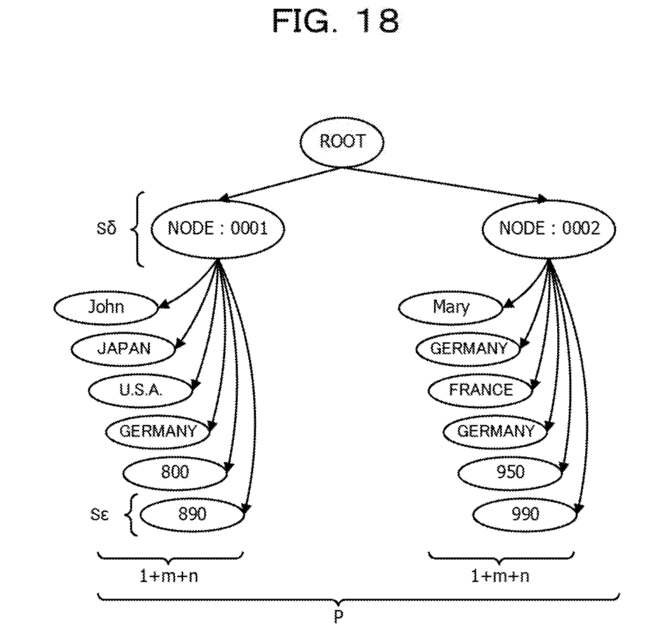

FIG. 18 illustrates an example of a tree structure. In the case where the above-described method is applied to three tables illustrated in FIGS. 15A to 15C, when the employee code is regarded as the key information, the tree structure illustrated in FIG. 18 is generated. For example, an association relationship among three tables is represented by the node to manage the plurality of attribute values having different attributes at the same node.

In this case, the number of nodes is represented by P and the number of attribute values under each node is represented by (1+m+n). When the data size of the employee code of each node is Sδ and the data size of the attribute value under the node is Sε, the size of the data to be retrieved is represented by P*Sδ+P*(m+n)*Sε.

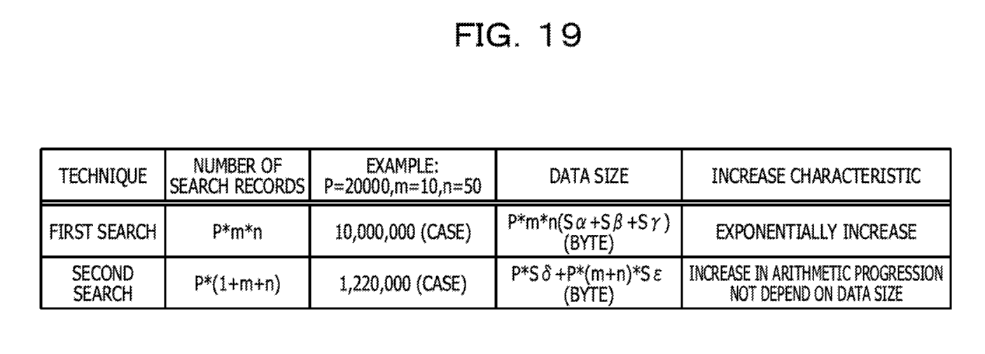

FIG. 19 illustrates an example of the search. In FIG. 19, a first search performed by using the materialized view and a second search performed by the above-described method are illustrated. For example, when the number of employees is 20000, and m=10 and n=50, the record of P*m*n=20000*10*50=10000000 becomes the target of the search in the first search. In the second search, since P*(1+m+n)=20000*(1+10+50)=1220000, the records of the second search is approximately ⅛ of the first search. As such, when the materialized view is used, the number of records and the data size are exponentially increased. As a result, when the number of employees increases, the materialized view may not be actually generated. Although the materialized view is generated, the processing may not be performed in real time. In the above-described method, since the number of records and the data size are increased in arithmetical progression as compared with the case where the materialized view is used, the data size may not be explosively increased even though the number of managed attributes and the number of attribute values increase.

When the search is executed by using the materialized view, both the update of the original table and regeneration of the materialized view are performed, and as a result, the processing delay may occur. In the above-described method, the processing delay may not occur. Since the data is not wholly regenerated and is partially updated, the data may be updated in real time.

For example, a functional block configuration of the above-described information processing apparatus 1 may not coincide with an actual program module configuration.

The configuration of each of the above-described tables is merely an example and is not limited to the above-described configuration. Even in a processing flow, a processing order may be changed and may be executed in parallel as long as the processing result is not changed.

Information other than the information such as the employee code may be used as the key information. For example, when the medical contents of a certain hospital are managed as an examination data table, a medicine data table, and an accounting data table, since a patient ID of the examination data table and a customer ID of the accounting data table are association keys that associate the tables, the values of the patient ID and the customer ID may be used.

For example, a file name of sensor data transmitted from hundreds of servers installed in a server room may be represented as “server name+time”. As a result, when the sensor data is set as the search target, the server name acquired from the file name of the sensor data may be used as the key information.

For example, action data may be acquired until the customer completes shopping after holding a shopping basket in his/her hand by a sensor tag mounted on the shopping basket. In this case, the action called the shopping is regarded as a transaction, and as a result, the key information may be allocated not to the shopping basket but to the action called the shopping itself.

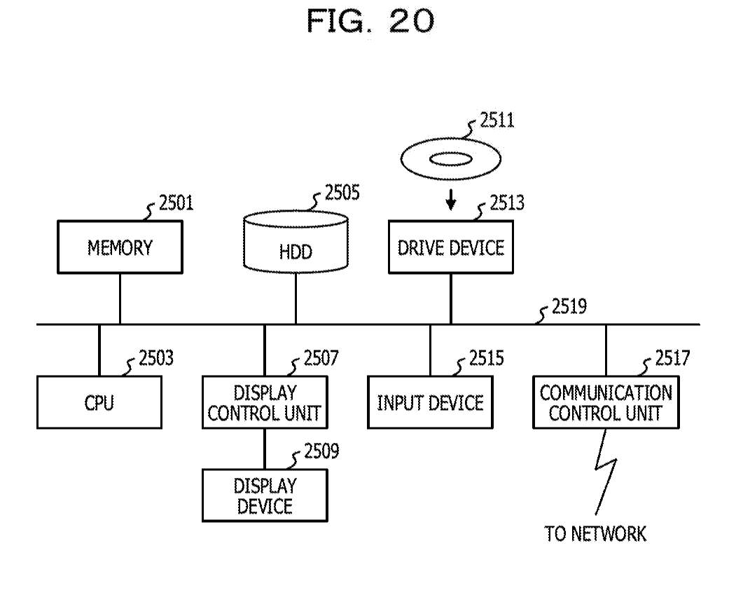

FIG. 20 illustrates an example of a functional block of a computer. For example, the information processing apparatus 1 may be a computer apparatus illustrated in FIG. 20. In the computer apparatus, a memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 for connection to a network are coupled via a bus 2519, as illustrated in FIG. 20. An operating system (OS) and an application program for performing the above-described processing are stored in the HDD 2505, and are read from the HDD 2505 to the memory 2501 when executed by the CPU 2503. The CPU 2503 controls the display control unit 2507, the communication control unit 2517, and the drive device 2513 according to the processing contents of the application program to perform a certain operation. The data which is being processed is mainly stored in the memory 2501, but may be stored in the HDD 2505. For example, the application program for performing the above-described processing may be distributed while stored in the computer readable removable disk 2511, and then installed in the HDD 2505 from the drive device 2513. The application program may be installed in the HDD 2505 via the network such as the Internet, etc. and the communication control unit 2517. In the computer apparatus like this, hardware including the CPU 2503, the memory 2501, etc., and the OS, programs including the application program, etc. organically cooperate with each other to implement above described various functions.

The management data storing unit 109 may be provided in the memory 2501 and the data storing unit 110 may be provided in the HDD 2505.

The search processing method includes: (A) receiving a search condition; (B) based on first information which associates a first attribute value of a first attribute, which is unique, with an attribute value group including a second attribute value of one or more second attributes other than the first attribute, determining whether the attribute value group associated with the first attribute value satisfies the search condition for each first attribute value; and (C) outputting the first attribute value associated with the attribute value group determined to satisfy the search condition.

Since the association operation is not performed and the data such as the materialized view is not used, an acceleration of the search and a decrease in the amount of data used in the search may be compatible.

The first information may include second information associating the first attribute value of the first attribute with an identifier of the second attribute value of the one or more attributes other than the first attribute and third information associating the identifier of the second attribute value of the one or more attributes other than the first attribute with the second attribute value. In the process of determining whether the attribute value group satisfies the search condition, (b1) the identifier of the second attribute value of the one or more attributes other than the first attribute associated with the first attribute value may be specified based on the second information for each first attribute value and the second attribute value associated with the specified identifier is specified based on the third information, and it may be determined whether the specified first attribute value satisfies the search condition. The second information and the third information like this may have a smaller size than the data used in the materialized view.

The search processing method may further include (D) receiving the first attribute value of the first attribute and the second attribute value of the attribute other than the first attribute, (E) determining whether the received first attribute value is included in the second information, (F) associating the identifier of the second attribute value with the first attribute value included in the second information when the first attribute value is included in the second information, and (G) adding associating the second attribute value with the identifier of the second attribute value to the third information. In actuality, information to be retrieved may be updated in real time.

The search processing method may further include (H) adding associating the first attribute value with the identifier of the second attribute value to the second information when the first attribute value is not included in the second information and (I) adding associating the identifier of the second attribute value with the second attribute value to the third information. In actuality, the information to be retrieved may be updated in real time.

The search condition may include one or a plurality of combinations of the attribute and the attribute value of the attribute.

A program for executing the processing by the above-described method in the computer may be prepared. The program may be stored in computer readable memory media or memory devices including, for example, a flexible disk, a CD-ROM, an optical magnetic disk, a semiconductor memory, a hard disk, etc. An intermediate processing result may be temporarily kept in memory devices including a main memory, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A search processing method comprising:
receiving, by a computer, a search condition;
determining, based on first information which associates a first attribute value of a first attribute, which is unique, with an attribute value group including a second attribute value of one or more second attributes other than the first attribute, whether the attribute value group associated with the first attribute value satisfies the search condition for each of the first attribute value; and
outputting the first attribute value associated with the attribute value group determined to satisfy the search condition.

2. The search processing method according to claim 1, wherein the first information includes second information associating the first attribute value with an identifier of the second attribute value and third information associating the identifier of the second attribute value with the second attribute value,
the identifier of the second attribute value associated with the first attribute value is specified based on the second information for each of the first attribute value, and
the first attribute value associated with the specified identifier is specified based on the third information and whether the specified second attribute value satisfies the search condition is determined.

3. The search processing method according to claim 2, further comprising:
receiving the first attribute value and the second attribute value;
determining whether the first attribute value is included in the second information;
associating the identifier of the second attribute value with the first attribute value included in the second information when the first attribute value is included in the second information; and
adding associating the identifier of the second attribute value with the second attribute value to the third information.

4. The search processing method according to claim 2, further comprising:
adding, when the first attribute value is not included in the second information, associating the first attribute value with the identifier of the second attribute value to the second information; and
adding associating the identifier of the second attribute value with the second attribute value to the third information.

5. The search processing method according to claim 1, wherein the search condition includes one or more combinations of the first attribute and the first attribute value.

6. A search processing apparatus comprising:
a memory that sotres a origram; and
a processor that performs, based on the program, operations of:
receiving a search condition;
determining, based on first information which associates a first attribute value of a first attribute, which is unique, with an attribute value group including a second attribute value of one or more second attributes other than the first attribute, whether the attribute value group associated with the first attribute value satisfies the search condition for each of the first attribute value; and
outputting the first attribute value associated with the attribute value group determined to satisfy the search condition.

7. The search processing apparatus according to claim 6, wherein the first information includes second information associating the first attribute value with an identifier of the second attribute value and third information associating the identifier of the second attribute value with the second attribute value,
the identifier of the second attribute value associated with the first attribute value is specified based on the second information for each of the first attribute value, and
the first attribute value associated with the specified identifier is specified based on the third information and whether the specified second attribute value satisfies the search condition is determined.

8. The search processing apparatus according to claim 7, wherein the processor:
receives the first attribute value and the second attribute value;
determining whether the first attribute value is included in the second information;
associates the identifier of the second attribute value with the first attribute value included in the second information when the first attribute value is included in the second information; and
adds associating the identifier of the second attribute value with the second attribute value to the third information.

9. The search processing apparatus according to claim 7, wherein the processor:
adds, when the first attribute value is not included in the second information, associating the first attribute value with the identifier of the second attribute value to the second information; and
adds associating the identifier of the second attribute value with the second attribute value to the third information.

10. The search processing apparatus according to claim 6, wherein the search condition includes one or more combinations of the first attribute and the first attribute value.

11. A non-transitory computer-readable recording medium storing a search processing program which causes a computer to execute operations, the operations comprising:
receiving, by a computer, a search condition;
determining, based on first information which associates a first attribute value of a first attribute, which is unique, with an attribute value group including a second attribute value of one or more second attributes other than the first attribute, whether the attribute value group associated with the first attribute value satisfies the search condition for each of the first attribute value; and
outputting the first attribute value associated with the attribute value group determined to satisfy the search condition.

12. The non-transitory computer-readable recording medium according to claim 11, wherein the first information includes second information associating the first attribute value with an identifier of the second attribute value and third information associating the identifier of the second attribute value with the second attribute value,
the identifier of the second attribute value associated with the first attribute value is specified based on the second information for each of the first attribute value, and
the first attribute value associated with the specified identifier is specified based on the third information and whether the specified second attribute value satisfies the search condition is determined.

13. The non-transitory computer-readable recording medium according to claim 12, further comprising:
receiving the first attribute value and the second attribute value;
determining whether the first attribute value is included in the second information;
associating the identifier of the second attribute value with the first attribute value included in the second information when the first attribute value is included in the second information; and
adding associating the identifier of the second attribute value with the second attribute value to the third information.

14. The non-transitory computer-readable recording medium according to claim 12, further comprising:
adding, when the first attribute value is not included in the second information, associating the first attribute value with the identifier of the second attribute value to the second information; and
adding associating the identifier of the second attribute value with the second attribute value to the third information.

15. The non-transitory computer-readable recording medium according to claim 11, wherein the search condition includes one or more combinations of the first attribute and the first attribute value.
